(19) United States
(12) Patent Application Publication
(10) Pub. No.: US 2026/0187859 A1
(43) Pub. Date: Jul. 2, 2026

(54) CONTENT GENERATION SYSTEM USING MACHINE LEARNING

(71) Applicant: Expedia, Inc., Seattle, WA (US)

(72) Inventors: Danny Godbout, Seattle, WA (US); Abi Ashok, Seattle, WA (US); Kate Goff, Seattle, WA (US); Rohit Kamath, Seattle, WA (US); Bogdan Popp, Seattle, WA (US); Mallory Taylor, Seattle, WA (US); Rouzbeh Davoudi, Seattle, WA (US); Aniket Sakpal, Seattle, WA (US)

(73) Assignee: Expedia, Inc., Seattle, WA (US)

(21) Appl. No.: 19/436,441

(22) Filed: Dec. 30, 2025

Related U.S. Application Data
(60) Provisional application No. 63/740,894, filed on Dec. 31, 2024.

(51) Int. Cl. G06T 11/00

(52) U.S. Cl. CPC G06T 11/00

(57) ABSTRACT

Systems and methods are described for generating and refining videos in response to receiving agent inputs. Example systems can be configured to obtain, from a client device, a request to generate a set of images (including videos). The systems can be configured to determine, responsive to the request, a first image from among a dataset comprising a plurality of predetermined images using the one or more aspects. In some examples, the system can be configured to provide the first image and a prompt to a machine learning model to cause the machine learning model to generate the set of images as an output. In response to obtaining the set of images from the machine learning model, the systems described can provide the set of images to cause the client device to display at least one image of the set of images.

### CROSS-REFERENCE TO RELATED APPLICATION

The present application claims the benefit of, and priority to, U.S. Provisional Patent Application No. 63/740,894 filed on Dec. 31, 2024, and titled “CONTENT GENERATION SYSTEM USING MACHINE LEARNING,” the contents of which are hereby incorporated in their entirety for all purposes.

### BACKGROUND

Conventional video editing techniques typically involve an individual using a computing device to access and manipulate video footage (represented as a series of one or more images) by splicing cuts from multiple videos and adjusting rates of speed, lighting, etc., to establish seamless transitions between each. But these techniques can allow for a loss of quality during the editing process, particularly in linear editing systems where repeated splicing and copying can degrade footage quality. Further, the potential for technical issues such as file corruption or system crashes when handling large video files can disrupt workflows, causing the individual editing the video to expend additional time and computing resources to recreate the files or lost work product.

### SUMMARY

For the aforementioned reasons, there is a need for systems and methods that allow for the generation and refinement of videos in response to receiving inputs.

In an embodiment, a system is disclosed. The system can include at least one processing circuit. The at least one processing circuit can include at least one memory and one or more processors configured to: obtain, from a client device, a request to generate a set of images, text, video, sound, etc., the request indicating one or more aspects to represent in the set of images; determine, responsive to the request, a first image from among a dataset including a plurality of predetermined images using the one or more aspects; provide the first image and a prompt to a machine learning model to cause the machine learning model to generate the set of images as an output, the prompt including one or more predetermined criteria, wherein providing the prompt to the machine learning model configures the machine learning model to generate the set of images in accordance with the one or more predetermined criteria; and in response to obtaining the set of images from the machine learning model, provide the set of images to cause the client device to display at least one image of the set of images.

In some aspects, the one or more processors can be further configured to: provide the first image to the client device to cause the client device to display the first image; and in response to providing the first image to the client device, obtain a confirmation from the client device to use the first image to generate the set of images.

In aspects, the one or more processors can be further configured to: provide the first image to the client device to cause the client device to display the first image; and in response to providing the first image to the client device, obtain a confirmation from the client device not to use the first image to generate the set of images; provide a plurality of images to the client device to cause the client device to display at least one image from among the plurality of images; and in response to providing the plurality of images to the client device, obtain a confirmation from the client device indicating a selected image from among the plurality of images.

In at least some aspects, the one or more processors can be further configured to: provide a plurality of images including the first image to the client device to cause the client device to display at least the first image; and in response to providing the plurality of images to the client device, obtain a confirmation from the client device indicating the first image from among the plurality of images.

In some aspects, the one or more processors can be further configured to: determine a context from the request based on the one or more aspects indicated by the request to generate the set of images, and wherein the one or more processors configured to determine the first image are configured to: filter the dataset for a subset of predetermined images that are compatible with the context; and determine the first image from the subset of predetermined images based on the one or more aspects indicated by the request to generate the set of images.

In aspects, the one or more processors can be further configured to: extract a first embedding from the one or more predetermined criteria using an encoder, the first embedding representing a style, and wherein the one or more processors configured to cause the machine learning model to generate the set of images are configured to: provide the first embedding to the machine learning model to cause the machine learning model to generate the set of images in accordance with the style.

In at least some aspects, the request to generate the set of images can include a first request to generate a first set of images, and the one or more processors can be further configured to: obtain a second request to generate a second set of images, the second request including an updated prompt configured to cause the machine learning model to generate the second set of images in accordance with one or more updates; and provide the first image and a second prompt to the machine learning model to cause the machine learning model to generate an updated set of images as a second output, the second prompt including the prompt, the updated prompt, and the one or more predetermined criteria.

In some aspects, the request to generate the set of images can include a first request to generate a first set of images, and the one or more processors can be further configured to: obtain a second request to generate an updated set of images based on a second image; determine the second image based on the second request, the second image included in the dataset including the plurality of predetermined images; and provide the second image and the prompt to the machine learning model to cause the machine learning model to generate an updated set of images as a second output.

In at least some aspects, the request to generate the set of images can include a first request to generate a first set of images, and the one or more processors can be further configured to: obtain a second request from client device to update the set of images, the second request including a second prompt indicating one or more updated aspects to represent in an updated set of images; provide the first image and a third prompt to the machine learning model to cause the machine learning model to generate the updated set of images as a second output, the third prompt including the prompt, the second prompt, and the one or more predetermined criteria.

In aspects, the one or more processors can be further configured to: determine an updated context from the second request based on the one or more updated aspects indicated by the second prompt, filter the dataset for an updated subset of predetermined images that are compatible with the updated context; determine a second image from the updated subset of predetermined images based on the one or more aspects indicated by the second prompt; and provide the second image and a third prompt to a machine learning model to cause the machine learning model to generate the updated set of images as a second output, the third prompt including the second prompt and the one or more predetermined criteria.

In at least some aspects, the one or more processors can be further configured to: in response to obtaining the set of images as the output of the machine learning model, provide the set of images to an agent-based machine learning model to cause the agent-based machine learning model to output a score; compare the score to an approval threshold value established for an organization; and in response to comparing the score to the approval threshold value, providing the set of images to one or more user devices to cause the one or more user devices to display at least one image of the set of images.

In some aspects, the one or more processors can be further configured to: in response to obtaining the set of images as the output of the machine learning model, provide the set of images to an agent-based machine learning model to cause the agent-based machine learning model to output a score; in response to comparing the score to an approval threshold, determine that the score does not satisfy the approval threshold; and apply one or more updates to the prompt to configure the machine learning model to generate an updated set of images as a second output; and provide the updated set of images to cause the client device to display at least one image of the set of images.

In another embodiment, a method is disclosed. The method can include: obtaining, by one or more processing circuits and from a client device, a request to generate a set of images, the request indicating one or more aspects to represent in the set of images; determining, by the one or more processing circuits and responsive to the request, a first image from among a dataset including a plurality of predetermined images using the one or more aspects; providing, by the one or more processing circuits, the first image and a prompt to a machine learning model to cause the machine learning model to generate the set of images as an output, the prompt including one or more predetermined criteria, wherein providing the prompt to the machine learning model configures the machine learning model to generate the set of images in accordance with the one or more predetermined criteria; and in response to obtaining the set of images from the machine learning model, providing, by the one or more processing circuits, the set of images to cause the client device to display at least one image of the set of images.

In some aspects, method can include providing, by the one or more processing circuits, the first image to the client device to cause the client device to display the first image; and in response to providing the first image to the client device, obtaining, by the one or more processing circuits, a confirmation from the client device to use the first image to generate the set of images.

In at least some aspects, method can further include providing, by the one or more processing circuits, the first image to the client device to cause the client device to display the first image; in response to providing the first image to the client device, obtaining, by the one or more processing circuits, a confirmation from the client device not to use the first image to generate the set of images; providing, by the one or more processing circuits, a plurality of images to the client device to cause the client device to display at least one image from among the plurality of images; and in response to providing the plurality of images to the client device, obtaining, by the one or more processing circuits, a confirmation from the client device indicating a selected image from among the plurality of images.

In aspects, the method can further include providing, by the one or more processing circuits, a plurality of images including the first image to the client device to cause the client device to display at least the first image; and in response to providing the plurality of images to the client device, obtaining, by the one or more processing circuits, a confirmation from the client device indicating the first image from among the plurality of images.

In at least some aspects, the method can further including: determining, by the one or more processing circuits, a context from the request based on the one or more aspects indicated by the request to generate the set of images, and wherein determining the first image are configured to: filtering, by the one or more processing circuits, the dataset for a subset of predetermined images that are compatible with the context; and determining, by the one or more processing circuits, the first image from the subset of predetermined images based on the one or more aspects indicated by the request to generate the set of images.

In some aspects, the method can further include extracting, by the one or more processing circuits, a first embedding from the one or more predetermined criteria using an encoder, the first embedding representing a style, and wherein causing the machine learning model to generate the set of images includes: providing, by the one or more processing circuits, the first embedding to the machine learning model to cause the machine learning model to generate the set of images in accordance with the style.

In at least some aspects, the request to generate the set of images can include a first request to generate a first set of images, and the method can further include obtaining, by the one or more processing circuits, a second request to generate a second set of images, the second request including an updated prompt configured to cause the machine learning model to generate the second set of images in accordance with one or more updates; and providing, by the one or more processing circuits, the first image and a second prompt to the machine learning model to cause the machine learning model to generate an updated set of images as a second output, the second prompt including the prompt, the updated prompt, and the one or more predetermined criteria.

In yet another embodiment, one or more non-transitory computer-readable media are disclosed. The one or more non-transitory computer-readable media can include instructions which, when executed by one or more processors, cause the one or more processors to: obtain, from a client device, a request to generate a set of images, the request indicating one or more aspects to represent in the set of images; determine, responsive to the request, a first image from among a dataset including a plurality of predetermined images using the one or more aspects; provide the first image and a prompt to a machine learning model to cause the machine learning model to generate the set of images as an output, the prompt including one or more predetermined criteria, wherein providing the prompt to the machine learning model configures the machine learning model to generate the set of images in accordance with the one or more predetermined criteria; and in response to obtaining the set of images from the machine learning model, provide the set of images to cause the client device to display at least one image of the set of images.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an environment for generating and refining videos in response to receiving agent inputs, according to some implementations;

FIG. 2 is a sequence diagram of an implementation of generation and refinement of videos in response to receiving agent inputs;

FIG. 3 is a flow diagram of a method for generating and refining videos in response to receiving agent inputs, according to some implementations;

FIG. 4A is an example sequence diagram of an environment for generation and refinement of videos in response to receiving agent inputs, according to some implementations;

FIGS. 4B-4E illustrate another example sequence diagram of an environment for generation and refinement of videos in response to receiving agent inputs, according to some embodiments; and

FIG. 5 is an example sequence diagram of an implementation of generation and refinement of videos using generative machine learning models in response to receiving agent inputs, according to some embodiments.

The details of various embodiments of the methods and systems are set forth in the accompanying drawings and the description below.

### DETAILED DESCRIPTION

Systems can be configured as described herein to perform one or more operations when generating and/or updating sets of images (e.g., video shorts, videos, and/or the like). For example, systems described herein can be configured to obtain a request to generate a set of images (e.g., a video), where the request specifies one or more aspects to be represented in the set of images. These aspects can include, for example, specific actions, locations, etc., to depict, a number of different scenes to include, etc. These systems may identify, in response to the request, a first image included in a dataset of predetermined (e.g., curated) images to use when generating the set of images. In some examples, the systems described can then provide the first image to a machine learning (ML) model (also referred to as a “model” for simplicity) to cause the model to generate an output including the set of images. In some examples, the system can provide the set of images to one or more client devices to cause the client device(s) to display at least one of the images. In the examples described herein, the client device(s) can be operated by a video editor, a customer, and/or any other individual. While the techniques described herein discuss the generation of sets of images (e.g., where images can represent individual images, or frames that form a video stream), it will be understood that the concepts of the present disclosure can be to generate images, text, sound, etc.

As will be understood, the systems and methods described herein can provide multiple advantages when used to generate or update sets of images, particularly when compared to conventional techniques. One advantage is that the implementation of various ML-based techniques described herein can drastically reduce editing time that would otherwise be expended as individuals perform certain tasks (e.g., color correction, audio adjustments, etc.). For instance, operations that might involve hours of manual updates can now be accomplished in minutes, allowing for rapid content production that meets the demands of today's fast-paced digital landscape. And from a resource perspective, these systems can consume less resources when compared to conventional techniques, particularly the dedication of processing cycles and memory involved in the manual editing of images and videos.

Additionally, the implementation of ML-based techniques when generating or updating images or videos can allow for the introduction of information across vast datasets by the models described herein that, again, would require multiple hours, days, etc., to collect and access during the image or video generation process. For example, a concise dataset of images representing various aspects (e.g., actions or activities to be performed, settings in which these actions or activities can be performed, etc.) can be established and images can be selected to be used as starting points for the generation of one or more images or videos. These selected images can be used by the models involved in generating the one or more images or videos described herein. Because these output images or videos can be generated based on vast datasets of images or videos that are used to train the models, agents (e.g., users, automated agents, etc.) can forgo searching comparatively larger datasets of images and videos when selecting a given image as a starting point. This can both reduce the consumption of processing and memory resources, as well as network resources involved in accessing and obtaining these images or videos from the larger datasets.

Various implementations of the present disclosure utilize a collaborative process between the processing/computing devices and/or machine learning models and human users, such that the human users are consulted or otherwise provided with opportunities to provide input, provide requests, or otherwise influence the process of generating the images or other content. Some such implementations may provide technical advantages (e.g., relative to fully automated content generation systems) such as reducing an amount of time and effort from users to manually modify the content generated by the processing system or completely re-run generation of the content and review multiple separate generated content sets without input during the generation process. Additionally, some such implementations may reduce the amount of processing resources to arrive at the final desired content by allowing the user to influence and provide feedback on the content generation process before the final content is generated, such that the processing resources can utilize the input during the generation process to arrive at the desired output through less processing iterations, less processor clock cycles, with lower power consumption, etc. as compared to fully generating the content multiple times to arrive at the desired output.

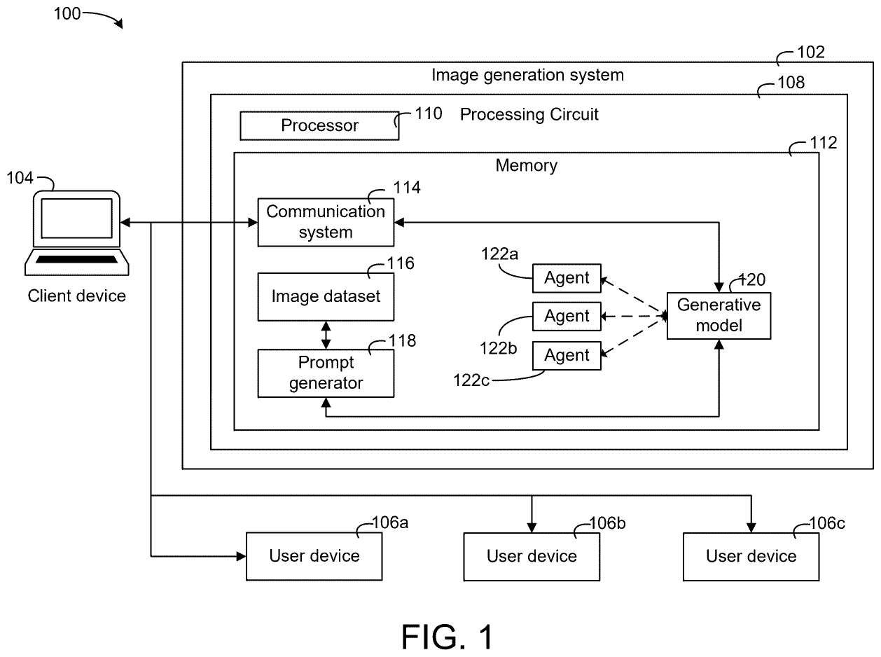

FIG. 1 is a block diagram of an environment 100 for generating and refining videos in response to receiving agent inputs, according to some implementations. The environment 100 can include an image generation system 102, a client device 104, and user devices 106a-106c (each referred to individually as user device 106 and collectively as user devices 106 where contextually appropriate). Various components depicted in FIG. 1 can belong to or otherwise be utilized by an organization involved in generating one or more images and or videos such as, for example, a media organization, a travel technology company, etc. The environment 100 is not confined to the components described herein and can include additional or other components, not shown for brevity, which are configured to be considered within the scope of the embodiments described herein. And as noted above, the environment 100 can be used to generate a variety of outputs including images, sets of images including multiple frames that form a video, text, etc.

The above mentioned components can be connected to each other through a network (not explicitly illustrated). Examples of the network can include, but are not limited to, public or private local-area-networks (LAN), wireless LAN (WLAN) networks, metropolitan area networks (MAN), wide-area networks (WAN), and the Internet. The network can include wired or wireless communications according to one or more standards or via one or more transport mediums. The communication over the network can be performed in accordance with various communication protocols such as Transmission Control Protocol and Internet Protocol (TCP/IP), User Datagram Protocol (UDP), and IEEE communication protocols. In one example, the network can include wireless communications according to Bluetooth specification sets or another standard or proprietary wireless communication protocol. In another example, the network can also include communications over a cellular network, including, e.g., a GSM (Global System for Mobile Communications), CDMA (Code Division Multiple Access), and EDGE (Enhanced Data for Global Evolution) network.

The image generation system 102 can be any computing device comprising one or more processors capable of executing the various tasks and processes described herein. For example, the image generation system 102 can include a processing circuit 108 that includes a processor 110. The processor 110 can include one or more various processors such as central processing units (CPUs), graphic processing units (GPUs), combinations thereof, etc. Non-limiting examples of such computing devices can include workstation computers, servers, laptop computers, desktop computers, and/or the like. While the image generation system 102 includes a single processing circuit, the image generation system 102 can include any number of computing devices operating in a distributed computing environment, such as a cloud environment. The processing circuit 108 can include a memory 112 including one or more non-transitory machine-readable storage mediums. The memory 112 can be associated with a communication system 114, an image dataset 116, a prompt generator 118, a generative model 120, and agents 122a-122c (each referred to individually as an agent 122 and collectively as agents 122 where contextually appropriate). While discussed as an image generation system 102, this system can be updated to apply to other modalities other than images or sets of images (e.g., frames forming a video) such as, for example, audio data, text data, and sensor data. These modalities can be processed using similar principles of deep neural networks, with techniques like convolutional neural networks (CNNs) for spatial data and recurrent neural networks (RNNs) for sequential data, enabling applications in speech recognition, natural language processing, and time series analysis, among others.

In some embodiments, the communication system 114 can be associated with instructions executable by the processor 110. For example, the communication system 114 can be associated with instructions that, when executed by the processor 110, cause the processing circuit 108 to establish one or more communication connections with the client device 104 and/or one or more user devices 106 using the network as described herein.

In some embodiments, the image dataset 116 can include image data associated with one or more images that are obtained from the client device 104 and/or one or more user devices 106. For example, the image dataset 116 and can include image data that is associated with one or more images captured in accordance with one or more predetermined criteria established by the organization involved in generating the one or more images or videos as described herein. In some examples, the one or more predetermined criteria can be associated with brand guidelines that describe one or more requirements (e.g., indicative of sets of rules and standards that describe how images should be generated by the image generation system 102). As will be understood, the one or more predetermined criteria can ensure consistency in visual appearance and messaging, helping to establish a strong and recognizable brand identity. One or more images can be represented as two-dimensional (2D) images such as RGB images, CMYK images, and/or the like.

In some embodiments, the prompt generator 118 can be associated with instructions executable by the processor 110. For example, the prompt generator 118 can be associated with instructions that, when executed by the processor 110, cause the processing circuit 108 to generate one or more prompts represented as one or more strings of text. In examples, the prompt generator 118 can generate the one or more prompts to be combined with one or more images that are provided to the generative model 120. As described herein, the prompt generator 118 can coordinate to generate and provide a prompt and an image selected from the image data set 1/16 to the generative model 120 to cause the generative model 120 to generate one or more images.

In some embodiments, the generative model 120 can be associated with instructions executable by the processor 110. For example, the generative model 120 can be associated with instructions that, when executed by the processor 110, caused the processing circuit 108 to generate the one or more images described herein. In examples, the generative model 120 can generate the one or more images in accordance with a prompt and or an image received by the prompt generator 118 and or the image dataset 116. In some embodiments, the generative model 120 can establish one or more communication connections with agents 122. For example, the generative model 120 can establish one or more communication connections with the agents 122 to coordinate and execute instructions resulting in the generation of the one or more images described herein.

In some embodiments, the agents 122 can be associated with instructions executable by the processor 110. For example, the agents 122 can be associated with instructions that, when executed by the processor 110, caused the processing circuit 108 to generate the one or more images in coordination with the generative model 120. Additionally, or alternatively, the agents 122 can be associated with the client device 104 and configured to establish communication connections with the client device 104 to obtain and execute instructions as described herein.

The client device 104 can be any computing device comprising one or more processors capable of executing the various tasks and processes described herein. For example, the client device 104 can include one or more workstation computers, laptop computers, tablets, and/or the like. In operation, various individuals can provide input via one or more input devices of the client device 104 (not explicitly illustrated) To cause the image generation system 102 to generate one or more images as described herein. In some embodiments, the client device 104 can receive input that causes the client device to obtain the one or more images generated by the image generation system 102 as described herein. The client device 104 can then display the one or more images via a display device (not explicitly illustrated).

The user device is 106 can be any computing device comprising one or more processors capable of executing the various tasks and processes described herein. For example, the user devices 106 can include one or more workstation computers, laptop computers on the tablets, and/or the like. In operation, various individuals (e.g., customers) can provide input via one or more input devices of the user devices 106 (not explicitly illustrated) to cause the user devices 106 to obtain the one or more images generated by the image generation system 102 as described herein. The user device is 106 can then display the one or more images via a display device (not explicitly illustrated).

With continued reference to FIG. 1, one or more components illustrated by FIG. 1 can be configured to obtain data from a client device 104, generate prompts or briefs, use the generated prompts or briefs along with selected images as inputs to a generative model 120, and generate sets of images in accordance with the input(s) provided to the generative model 120. In examples described herein, briefs can represent foundational document(s) that outline the key elements to be included in a promotional initiative. A brief can begin with a description of a target audience (e.g., one or more users of one or more user devices 106), detailing their demographics, preferences, and behaviors to ensure messaging resonates effectively. The brief can also specify the core objectives, such as increasing brand awareness, along with measurable outcomes to evaluate success. Additionally, a brief can include an overview of the creative direction, key messaging points, and preferred channels for communication for the one or more users. That are established can then be used to generate one or more prompts that are provided in combination with at least one image to the generative model 120. The generative model 120 can then generate a set of images as described herein in accordance with the prompt(s) and the at least one image. These sets of images can be reviewed by the individual operating the client device 104, iteratively updated as desired through the input of feedback that is used to update the prompts described above, and iterative execution of the generative model 120.

In some embodiments, the image generation system 102 can obtain a request to generate a set of images (e.g., representing a video short, a video, etc) to be published (e.g., as part of a marketing campaign). For example, the image generation system 102 can obtain the request to generate the set of images from the client device 104 The request can be generated by an individual providing input at the client device 104 and can indicate one or more aspects to represent in the set of images. In some embodiments, each request can have a semantic meaning that is diverse when compared to other requests received by the components of the image generation system 102. An individual can provide input at the client device 104 indicating the one or more aspects such as one or more actions, one or more objects, one or more locations, etc., to include when generating a set of images corresponding to a video short, a video, etc. In one example, the individual can provide input to the client device 104 in the form of a string such as “Generate a clip of a group of people hiking in Florida, and later relaxing on a beach in Florida.” In this example, the one or more aspects can specify that a group of people to be represented in the set of images, a first activity be performed by the group of people (hiking), a second activity performed by the group of people (relaxing on a beach), a location for the activities to be performed (Florida), and a sequence in which to generate the clips (e.g., first hiking, then relaxing on a beach). In various example implementations, the input may be a natural language input, such as an input not conforming to a predefined format or content and/or input that may have diverse semantic meanings. In some implementations, the input may be received via a chatbot or other type of collaborative input interface as described in further detail below. The client device 104 can then generate and provide request data associated with the request to the image generation system 102 using the communication system 114. In some examples, the client device 104 providing the request data to the image generation system 102 can cause the image generation system 102 to generate the set of images as described herein.

In some embodiments, the image generation system 102 can cause the processor 110 to execute one or more instructions and perform operations that, in turn, cause one or more systems associated with the memory 112 to be executed and generate the set of images. For example, the image generation system 102 can cause the processor 110 to execute one or more instructions to determine a first image included in the image dataset 116. The image dataset 116 can include a plurality of images that are usable to be provided as input to the generative model 120 when generating a set of images. As described, the images included in the image dataset 116 can be curated based on one or more predetermined criteria to establish ensure consistency in visual appearance. For example, the image generation system 102 and/or the client device 104 can provide the images included in the set of images to the image dataset 116, where each image satisfies at least some of the one or more predetermined criteria.

In some examples, the image generation system 102 can determine the first image by causing the processor 110 to execute one or more instructions. For example, the image generation system 102 can cause the processor 110 to filter the images included in the image dataset 116 in accordance with the one or more aspects specified by the request. For example, the request can indicate one or more aspects such as the number of individuals to represent in the set of images, one or more activities to be performed in the set of images, etc. Each generation system 102 can then filter the images included in the image dataset 116 by comparing the one or more aspects to one or more tags associated with each image. In some embodiments, the request can be represented as a string of text, one or more images, or combinations thereof. In examples, the image generation system 102 can be configured to filter the image dataset 116 to identify images that satisfy (e.g., meet) the one or more aspects of the request by comparing the string of text, aspects of the one or more images included in the request, etc., to the images stored in the image dataset 116.

In some embodiments, the image generation system 102 can select the first image from among the images available in the image dataset 116 and cause the communication system 114 to provide the first image to the client device 104 to be displayed. In this example, in response to displaying the first image, the client device 104 can receive input indicating that the first image is either accepted or not accepted and provide a confirmation to the image generation system 102 via the communication system 114. In some examples where the first image is accepted, the image generation system 102 then generate the set of images as described herein. In some examples where the first image is not accepted, the image generation system 102 can then identify a plurality of images that may satisfy at least portions of the request from the image dataset 116 and provide the plurality of images to be displayed on the client device 104. In this example, in response to input at the client device 104 indicating that one or more of the images are selected to be used when generating the set of images, the client device 104 can provide the indication to the image generation system 102 via the communication system 114. The image generation system 102 can then cause the processor 110 to execute operations that cause the generative model 120 to generate the set of images based on the selected image.

In some examples, the image generation system 102 can be configured to generate one or more alternative images based on the first image being accepted or not accepted. For example, the image generation system 102 can be configured to generate an image in response to receiving feedback from the client device 104. In this example, the feedback can indicate one or more features of the first image that are to be updated (e.g., added, removed, changed/adjusted, etc.) and used when generating sets of images as described here in. The one or more alternative images can be generated using a model that is similar to the generative model 120 of FIG. 1. For example, the image generation system 102 can be configured to generate input data based on the feedback received from the client device 104 and provide that input data to a generative model that is configured to generate individual images in response to receiving the input data. The generation system 102 can then perform one or more operations when generating sets of images as described herein using the image or images generated in response to receiving the feedback from the client device 104.

In some embodiments, the image generation system 102 can determine a context based on the request. For example, the image generation system 102 determine the context based on the one or more aspects indicated by the request to generate the set of images. The context can include, for example, information that is usable to filter the images included in the image dataset 116 but that is not explicitly stated in the request. For example, the request can indicate that a set of images be generated including a first scene and a second scene, selection of an example image included in the image dataset 116 (e.g., by the individual controlling the client device 104, also referred to as an agent where contextually appropriate), and the image generation system 102 can further determine that the context indicates that the images be captured during daytime settings. In some embodiments, the image generation system 102 can then filter the images included in the image dataset 116 to determine the first image that is to be used when generating the set of images. For example, in view of the context described above, the image generation system 102 can filter the images in the image dataset 116 that are captured at night from being selected for use when generating the set of images.

In some embodiments, the image generation system 102 can generate the set of images using a model. For example, the image generation system 102 can generate the set of images using the generative model 120. In this example, the image generation system 102 can provide the first image and a prompt to the generative model 120 to cause the generative model to generate the set of images as an output. In some embodiments, the image generation system 102 can configure the prompt generator 118 to generate one or more of the prompts described here in. For example, the image generation system 102 can cause the prompt generator 118 to generate one or more strings of text that are later used to generate embeddings representing prompts as described herein. In another example, the image generation system 102 can cause the prompt generator 118 to generate the one or more strings of text and include the one or more strings of text in the prompt provided to the generative model 120 when generating sets of images (e.g., video shorts, videos, etc.). Some embodiments, the prompt generator 118 can be configured to select prompts from a set of one or more predetermined prompts. For example, the prompt generator can be configured to select prompts from a set of one or more predetermined prompts that represent templates that can be used by the generative model 120 to guide the generative model when generating the set of images. These templates can include one or more strings of text that represent actions to be performed criteria to use when establishing scenes represented by the set of images, etc. In some embodiments, the templates can also include information usable to overlay text onto the set of images, music, etc.

In some embodiments, the generative model 120 can include one or more components of a diffusion model. For example, the generative model 120 can include a generative model that creates new data samples, such as images or sounds, by simulating a diffusion process. the generative model 120 can operate through two main phases: a forward diffusion process, gradually adding noise to input data such as an image; and reverse diffusion process, where the generative model 120 learns to iteratively remove noise from random input to generate coherent outputs (e.g., images). The generative model 120 can producing images responsive to the request by implementing text-to-image and text-to-video generation.

To generate the set of images, the image generation system 102 can provide the first image and a prompt to the image generation system 102 to cause the image generation system 102 to generate an output representing the set of images. In response to receiving the first image and the prompt, the prompt can first be encoded using a text encoder, such as contrastive language-image pre-training) CLIP or a transformer model, which converts the prompt into a text embedding (e.g., a latent representation) that captures the semantic meaning of the prompt. Similarly, the first image can be encoded using an image encoder which converts the first image into an image embedding (e.g., a latent representation) that captures the features represented by the first image. The generative model 120 can then use the text embedding and the image embedding as conditions during the generation process, starting from an image including random noise and iteratively refining the image based on the information derived from the text. This conditional generation allows the model to produce visual content that aligns with the semantic meaning represented by the prompt, resulting in highly relevant and contextually appropriate images or videos.

In some embodiments, the image generation system 102 cause the prompt generator 118 to generate and/or update the prompts provided to the generative model 120. For example, the image generation system can cause the prompt generator 118 to generate the prompts provided to the generative model 120 based on data received from the client device 104. In some examples the prompt generator 118 can be configured to generate the prompt using a machine learning model such as a large language model (LLM). In these examples, the LLM can be configured to receive at least a portion of the input provided by the individual controlling the client device 104 along with instructions to generate a prompt that is usable as input to the generative model 120. The instructions to generate the prompt can include instructions that configure the LLM to determine an intent based on the input provided by the individual controlling the client device 104.

In some embodiments, the image generation system 102 can generate (e.g., update) the prompt to include one or more predetermined criteria. For example, in addition to information extracted from the request, the image generation system 102 can include one or more strings of text that represent one or more requirements (e.g., indicative of sets of rules and standards that describe how images should be generated by the image generation system 102). Portions of the prompt can be pre-established and the image generation system 102 can be configured to generate sets of images in accordance with the requirements established by the set of rules represented by the prompt. In some embodiments, the prompt can include an embedding (e.g., a first embedding) representing a style in which the set of images are to be generated. For example, the image generation system 102 can cause text associated with the one or more predetermined criteria to be provided to the text encoder described above. The text encoder can then generate the embedding, and the image generation system 102 can include the embedding in the prompt provided to the generative model 120 when generating the set of images. In this way, the image generation system 102 can be configured to cause the generative model 120 to generate the set of images in accordance with a particular style, set of styles, etc.

In some embodiments, the image generation system 102 can be configured to compare the set of images output by the generative model 120 to the request provided by the individual controlling the client device 104. For example, the image generation system 102 can cause the generative model 120 to generate a plurality of sets of images (e.g., a plurality of videos). The image generation system 102 can then compare each set of images to the request and/or to the intent inferred from the request by the LLM described above. In some embodiments, the image generation system 102 can cause the prompt generator 118 to update the prompt used to generate the set of images based on feedback (e.g., indicating one or more features about the set of images to be changed) provided by the individual controlling the client device 104. In response to updates to the prompt and/or selection of one or more different images to use when generating the set of images, the image generation system 102 can cause iterative execution of the generative model 120. Additionally, or alternatively, The image generation system 102 can cause the prompt generator 118 to update the prompt and similarly cause iterative execution of the generative model 120.

In some embodiments, the image generation system 102 can provide the set of images generated by the generative model 120 to the client device 104 using the communication system 114. For example, in response to generation of the set of images by the generative model 120, the image generation system 102 can provide the set of images to cause the client device 104 to display at least one image of the set of images on a display device. In this example, the client device 104 can receive input from the individual controlling the client device 104 indicating whether the set of images are accepted or not accepted. In examples where the set of images are accepted, the client device 104 can provide a response to the image generation system 102 that configures the image generation system 102 to publish and/or make available for download the set of images by one or more user devices 106. In examples where the set of images are not accepted, the client device 104 can receive input indicating one or more aspects of the set of images to update (e.g., change). The image generation system 102 can then cause the generative model 120 to update the set of images as described herein.

In some embodiments, to update the set of images, the image generation system 102 can obtain a second request from the client device 104 to generate a second set of images. The second request can include a string of text usable to generate an updated prompt that is configured to cause the generative model 120 to generate the second set of images. In an example, can request can include one or more strings of text that indicate the one or more aspects of the set of images originally generated in response to the (initial) request that are to be changed, emphasized, etc. In this example, the image generation system 102 can cause the one or more strings of text to be provided to the text encoder described above, and the image generation system 102 can include (e.g., concatenate) the resulting text embedding with the prompt originally provided to the model. The image generation system can then provide the first image and the prompt including the text embedding generated to represent the updated prompt to the generative model 120 to cause the generative model 120 to generate the updated set of images as a second output. As will be understood, this process of obtaining second requests in response to feedback from the individual controlling the client device 104 when generating updated sets of images as outputs using the generative model 120 can be iteratively performed until the individual is satisfied with the set of images output by the generative model 120. In some implementations, in addition to or instead of strings of text, the user may provide input in one or more of various other manners, such as providing input images (e.g., revised versions of images generated by the image generation system 102, example images provided by the user, etc.). In some such implementations, the input may be translated into a format that can be used by the system to generate and/or modify content, such as by performing image processing on the input image to identify characteristics of the image such as one or more annotated or marked up portions of the image, one or more modified image portions, and/or one or more characteristics of the image.

Additionally, or alternatively, individual control on the client device 104 can provide an indication to change the first image used to generate the set of images when generating one or more updated sets of images. For example, the individual can provide input to the client device 104 indicating selection of one or more different images included in the image dataset 116. In another example, the individual can provide input to the client device 104 that caused the client device 104 to provide a different image stored on the client device 104 to the image generation system 102 using the communication system 114. The image generation system 102 can then include or substitute the first image on successive executions of the generative model 120 to generate the one or more second sets of images.

Some environments, the image generation system 102 can determine an updated context based on the second request received from the client device 104. For example, the client device 104 can include an indication to update one or more aspects represented by the first set of images. In the examples described above, where the set of images are generated to include a subset of images representing individuals hiking in Florida and another subset of images representing individuals relaxing on the beach in Florida, the updated contexts can be represented as a change that causes, for example, the first subset of image to be changed. In one example, the first subset of images can be changed to represent hiking in Florida without individuals visualized in the first subset of images, while the second subset of images (e.g., a subset of predetermined images) remains the same. Again, the client device 104 can display the second set of images and iteratively receive requests to update the second set of images until the individual controlling the client device 104 is satisfied with the output of the generative model 120.

In some embodiments, updates to the first set of images can be generated using agents 122 instead of, or in addition to, the updates requested by the individual controlling the client device 104. For example, the output of the generative model 120 can be provided to one or more of the agents 122. The agents 122 can then analyze the output of the generative model 120 and determine a score indicating a degree to which the set of images output by the image generation system conforms to the request provided by the client device 104 when initially generating the set of images and/or one or more subsequent requests to update the set of images received by the client device 104. The image generation system 102 can then cause the generative model 120 to be executed in accordance with the score. For example, in the image generation system 102 can cause the prompt generator 118 to update the prompts and or one or more images to be selected from the image dataset 116 that are different from the first image or successively selected images and provide the updated prompts and the selected image to the generative model 120. The generative model 120 can then generate an updated set of images that are provided to the agents 122 to again be scored. In some embodiments, where the score satisfies and approval threshold value, the set of images can be provided to the client device 104. Additionally, or alternatively, where the score does not satisfy the approval threshold value, the image generation system 102 can iteratively perform this process of updating the prompt and/or selecting different images to be used to generate the set of images. In some embodiments, the generative model 120 can generate a plurality of sets of images that are then scored by the agents 122. The image generation system 102 can then select a set of images from among the plurality of sets of images that has the highest score indicating that the set of images most closely conform to the requests. In addition to scoring the sets of images based on their conformance to the request, the agents 122 can score the sets of images based on whether the sets of images satisfy a quality threshold associated with the visual aesthetic of the sets of images, whether the sets of images satisfy one or more photography guidelines, and whether a combination of the scores generated by the agents 122 satisfies a cumulative score threshold.

In some embodiments, the agents 122 can include agents that are trained using a combination of predefined behavioral rules and adaptive learning algorithms. For example, each agent 122 can be assigned specific rules that indicate how the agent 122 will score the set of images output by the generative model 120, cause one or more updates to be made to the prompt used to generate the set of images, or select one or more different images from the image dataset 116 to be used when generating the set of images, etc. In some embodiments, the agents 122 can be represented as neural networks and trained using techniques, such as reinforcement learning, which enable the agents 122 to adapt their behaviors based on past experiences and interactions. In some embodiments, the agents 122 can operate in a simulated environment established by the image generation system 102, allowing the agents 122 to assess the sets of images output by the generative model 120, make decisions, and interact with one another to generate updates to the inputs to the generative model 120 when generating the sets of images described herein. In some embodiments, training can involve calibrating the outputs of the agents 122 (e.g., agent behaviors) against real-world data or theoretical models representing changes made to the sets of images output by the generative model 120 by individuals operating client devices that are the same as or similar to the client device 104 at earlier points in time to ensure that simulation outcomes align with expected results.

While the agents 122 can, in some implementations, including software agents, it should be understood that the present disclosure is not so limited. In various implementations, the agents 122 may be implemented using other algorithms or software constructs and/or may be implemented in whole or in part manually (e.g., by human assessment). Further, one or more of the functions described as provided by the agents 122 may be provided by systems external to the system 102, including, but not limited to, systems that may be controlled by third parties.

In some implementations, the request and/or subsequent input from a user may be received via a chat interface, such as a chatbot (e.g., generative chatbot operated using one or more generative AI models configured to autonomously or semi-autonomously communicate with users via natural language input and output). In some such implementations, the chat interface may be provided on and/or executed on the client device 104. The chat interface may be used to receive input from and/or provide output to the user at one or more points during the content generation process. In some examples, the chat interface may be used to perform one or more of: (1) receiving an initial request to generate a set of images from the user; (2) provide a candidate image or set of images based upon which the final set of images will be generated to the user for approval and/or feedback and receive the approval and/or feedback from the user, and provide any updated/modified candidate image or images for similar feedback; (3) provide interim content and/or questions to the user during the content generation process and receive feedback/responses from the user on the interim content and/or questions for use in generating the final content/set of images; and/or (4) providing the output set of images/content to the user for review and approval or feedback, where the feedback may be used to modify the output content and/or re-run part or all of the processing to generate new or modified images.

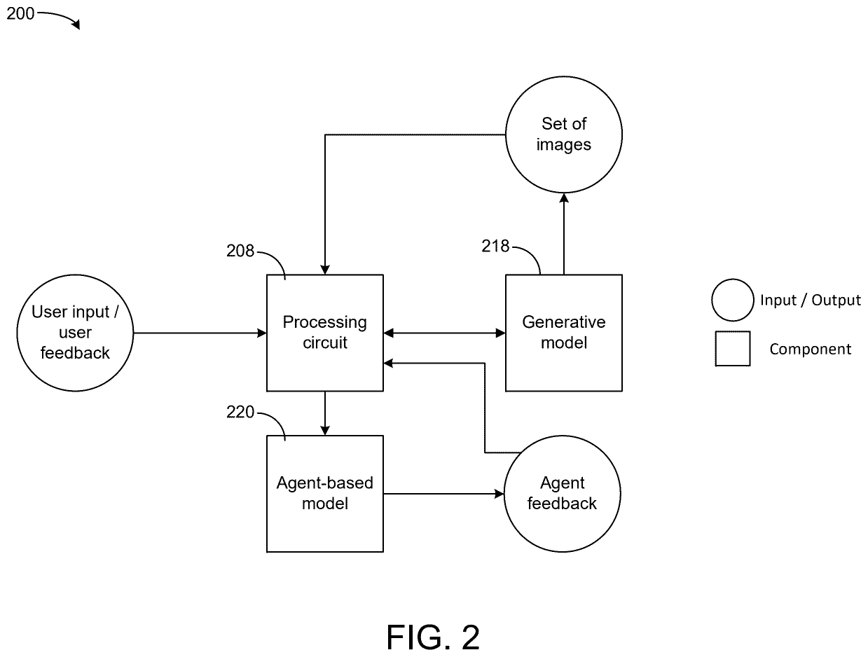

FIG. 2 is a sequence diagram of an implementation 200 of generation and refinement of videos in response to receiving agent inputs. In some examples, one or more aspects described herein with respect to implementation 200 can be performed by one or more devices of FIG. 1. For example, operations performed by the processing circuit 208, the agent-based model 220, and/or the generative model 218 can be performed by one or more of the processing circuit 108, the agents 122, and/or generative model 120 as described herein.

In some embodiments, the processing circuit 208 can receive user input at a first point in time period. For example, the user input received at the first point in time can include a request to generate a set of images such as a video short, a video, and/or the like. The processing circuit 208 can then generate a prompt that is provided to the generative model 218 and causes the generative model 218 to generate a set of images. For example, in response to receiving user input indicating a request to generate a set of images of individuals hiking in Florida and individuals later relaxing on a beach in Florida, the processing circuit 208 can generate a prompt that succinctly indicates that a set of images should be generated where individuals are shown hiking in Florida followed with a transition to individuals later relaxing on a beach in Florida. In examples, the processing circuit 208 can use a text encoder to generate a text embedding that represents the user input. Additionally, or alternatively, the processing circuit 208 can select an image from among a plurality of predetermined images that are compatible with a given organization (e.g., the organization's brand guidelines, marketing preferences, etc.). The processing circuit 208 then can combine the image selected from among the plurality of predetermined images with the prompts and provide both to the generative model 218 to cause the generative model 218 to generate the set of images in accordance with both the prompt and the selected image.

In response to the generative model 218 generating the set of images, the processing circuit 208 can obtain the set of images. The processing circuit 208 can then provide the set of images to the agent-based model 220. The agent-based model 220 can include one or more agents that are the same as, or similar to, the agents 122 of FIG. 1. The agent-based model 220 can then generate agent feedback indicating one or more aspects to change with respect to the set of images and/or a score for the set of images indicating a degree to which the set of images satisfies one or more criteria. While the implementation 200 shows an agent-based model 220 generating agent feedback that is used to update the set of images output by the generative model 218, it will be understood that the agent-based model can be replaced with a client device that is the same as, or similar to, the client device 104 of FIG. 1 and that feedback can be obtained from the individual controlling the client device and use similar by the processing circuit 208 to update the prompt and images involved in generating successively generated sets of images and refining the set of images.

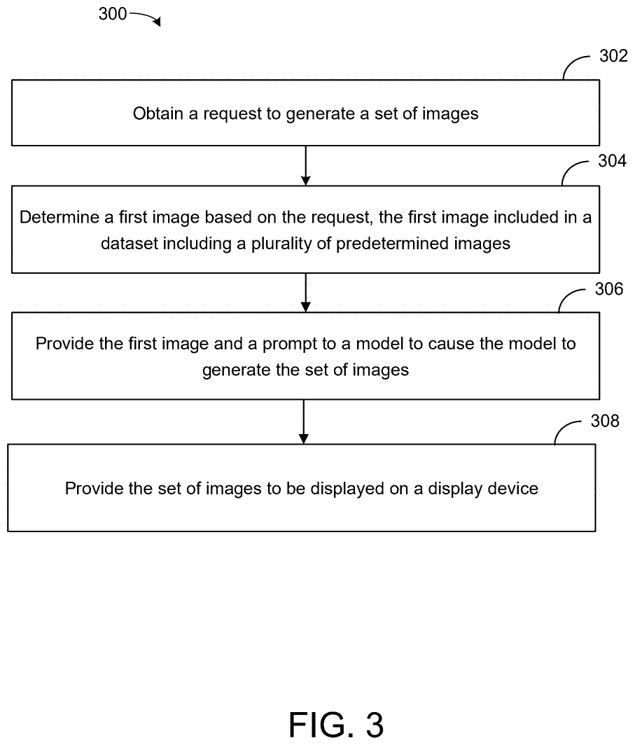

FIG. 3 is a flow diagram of a method 300 for generating and refining videos in response to receiving agent inputs, according to some implementations. The method 300 includes operations 302-308. However, other embodiments can include additional or alternative operations or can omit one or more operations altogether. The method 300 is described as being executed by an image generation system which can be the same as, or similar to, the image generation system 102 described in FIG. 1. However, one or more steps of the method 300 can be executed by any number of computing devices operating in the distributed computing system described in FIG. 1. For instance, one or more computing devices can locally perform part or all of the operations described.

At operation 302, the image generation system can obtain your request to generate a set of images. For example, the image generation system can obtain the request to generate the set of images from a client device (e.g., that is the same as, or similar to, the client device 104 of FIG. 1). In response to receiving the request, the image generation system can cause one or more components thereof to execute one or more operations to coordinate and generate a set of images as described herein.

At operation 304, the image generation system can determine a first image based on the request. For example, the image generation system can determine the first image based on the request by filtering an image dataset. In some examples, the image dataset can include a plurality of predetermined images that are curated based on one or more brand guidelines, etc.

At operation 306, the image generation system can provide the first image any prompts to a model to cause them all to generate the set of images. For example, the image generation system can provide the first image and the prompt to a model such as a machine learning model (e.g., a diffusion model, an agent-based machine learning model, etc.) to cause the model to generate an output. The output can represent the set of images and be generated in accordance with one or more predetermined criteria.

At operation 308, the image generation system can provide the set of images to be displayed on the display device. For example, the image generation system can provide the set of images to be displayed on a display device of a client device. In another example, where the individual that generated the request to generate the set of images approves of the set of images, the image generation system can make available the set of images to one or more user devices. In this example, the one or more user devices can obtain the set of images and display the set of images on a display device thereof.

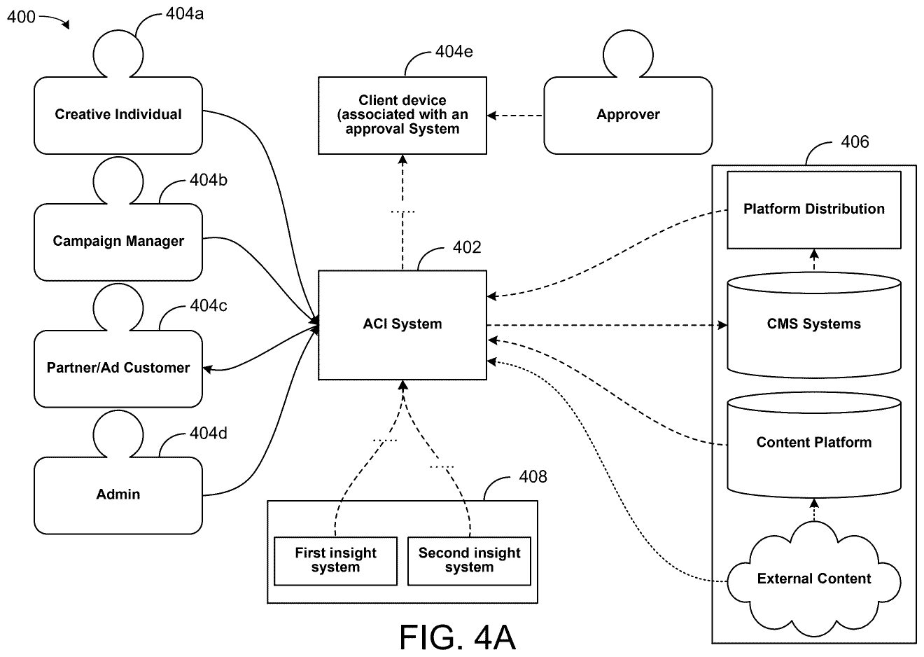

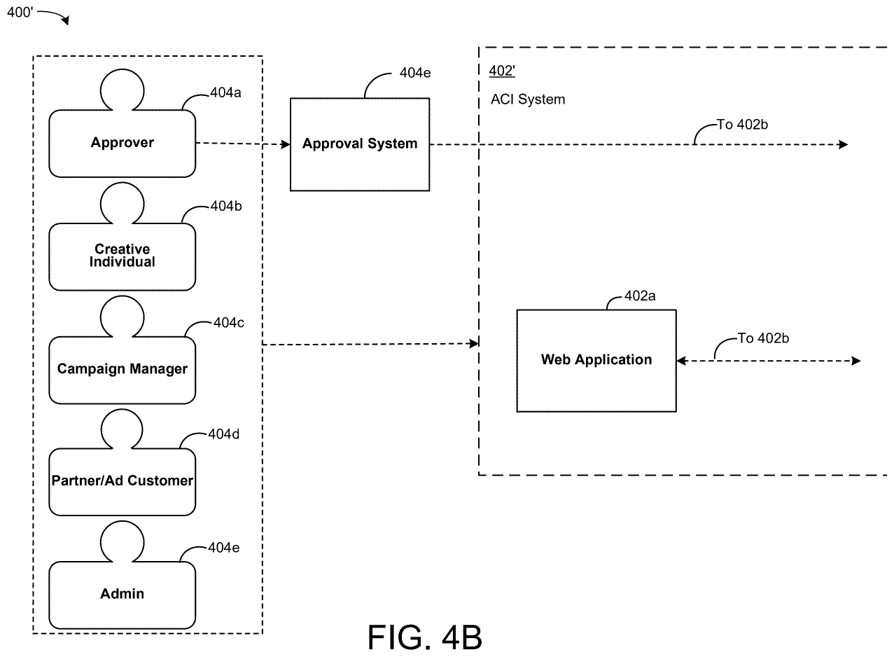

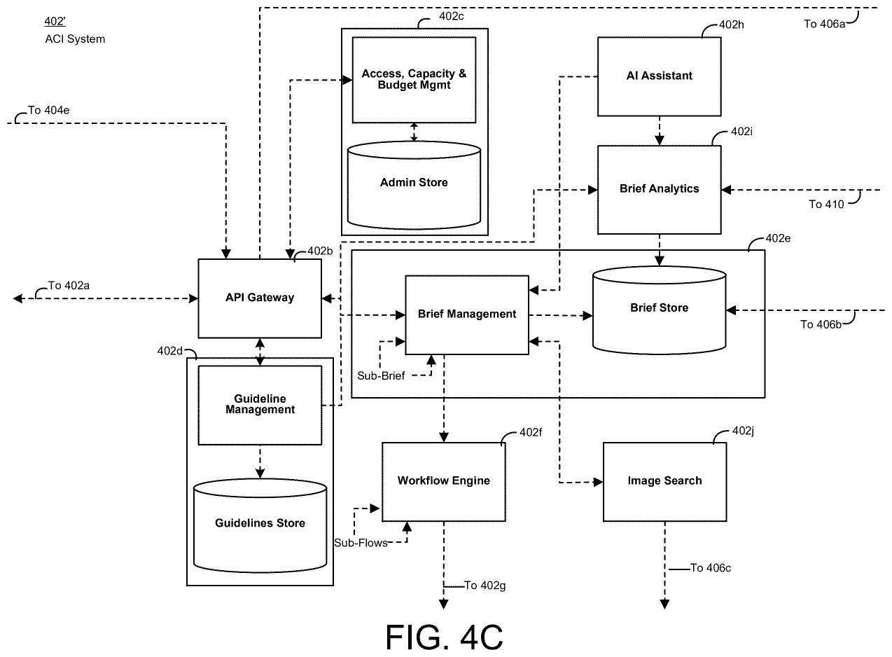

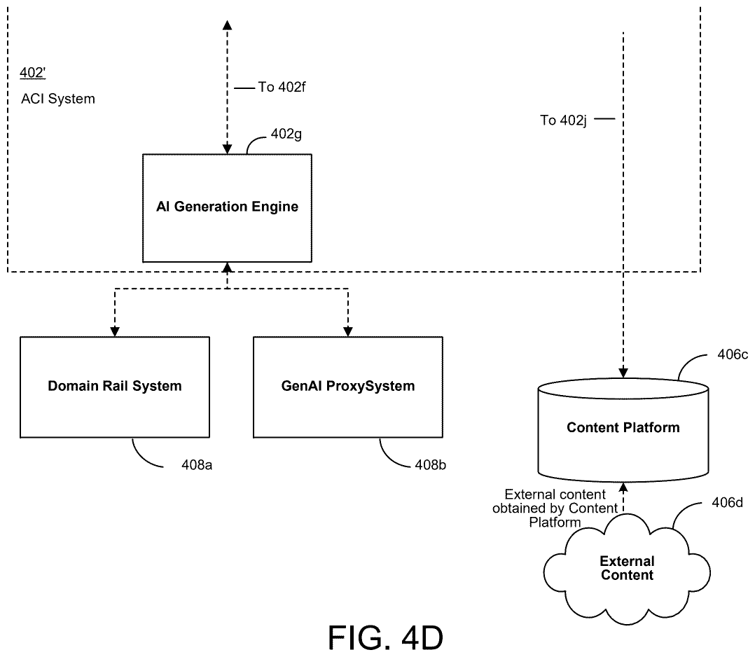

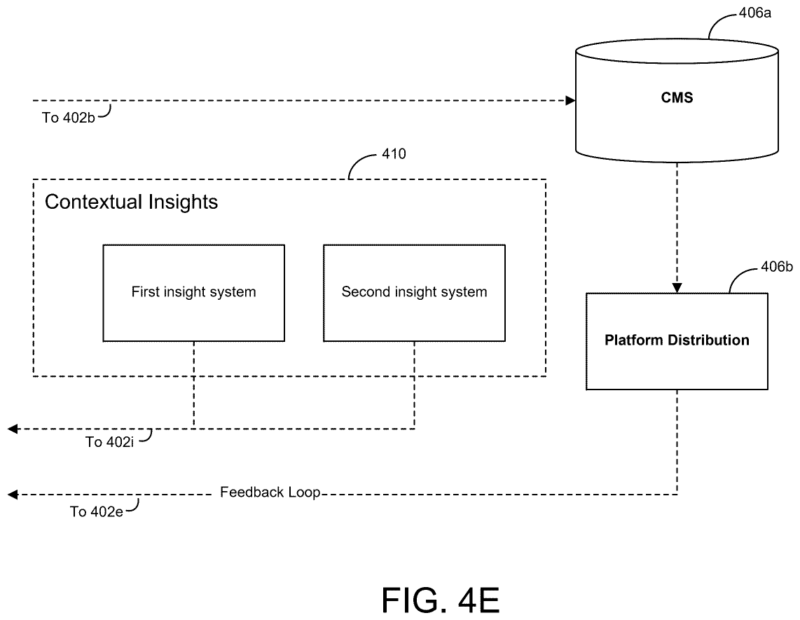

FIG. 4A is a sequence diagram of an environment 400 for generation and refinement of videos in response to receiving agent inputs. One or more aspects described herein with respect to the environment 400 can be performed by one or more devices of FIG. 1. In some embodiments, the environment 400 includes an artificial creative intelligence (ACI) system 402, one or more client devices 404a-404e that are associated with (e.g., controlled by) individuals that are submitting requests to the ACI system 402 to generate a set of images, external content databases 406 (including external content databases, etc.) that can be assessable by devices associated with, and/or accessible by, one or more users (e.g., customers, etc.), and an insight system 408. The ACI system 402 can be the same as, or similar to, the image generation system 102 of FIG. 1, the client devices 404a-404e can be the same as, or similar to, the client device 104 of FIG. 1, and the external content databases 406 can be the same as, or similar to, the user devices 106 of FIG. 1.

In some embodiments, the ACI system 402 can be configured to receive requests to generate sets of images from one or more of the client devices 404a-404d. For example, the ACI system 402 can be configured to receive one or more requests from client devices 404a-404c that are associated with individuals responsible for creating artifacts (also referred to as creatives and/or creative individuals), campaign managers responsible for coordinating campaigns (e.g., advertisement campaigns), partners or advertisement customers that are responsible for providing and/or consuming ad artifacts (e.g., sets of images), and administrators that control access to the ACI system 402. In some examples, the ACI system 402 can also be in communication with a client device 404e that is associated with an individual such as an approver that processes the artifacts for campaigns and determines whether or not to make the artifacts available for public publication.

In some embodiments, the external content databases 406 can be associated with individuals such as platform distributors, content management systems (CMS systems) that store or generate content and organize campaign assets, content platforms that store content property images, and external assets that can be used in creative flows when generating the sets of one or more images as described here in.

In some embodiments, an insight system 408 can be implemented to coordinate data analysis and campaign recommendations using integrated subsystems, including a first insight system and a second insight system. The insight system 408 can function as an orchestration layer that aggregates market and audience insights from multiple data sources to inform and guide creative decision-making within a content governance workflow. The first insight system can provide market-focused information based on partner-centric platforms, identifying trends or emerging opportunities across different campaign regions and demographics. The second insight system can supply provide information on traveler segments by evaluating preferences, platform usage, and behavioral patterns relevant to targeted audiences.

The insight system 408 can process input prompts or dataset queries and route them through the first insight system and the second insight system to obtain updated insight data. The system can combine structured metadata such as campaign category, location, and audience segment with the retrieved market and traveler analytics to generate contextual recommendations. For example, the first insight system can indicate that the ski travel market is trending upward among a specific traveler segment, and the second insight system can identify that this segment displays a high engagement rate on social media platforms such as Instagram. In response, the insight system 408 can generate a suggestion to direct marketing resources toward an a social media campaign focused on winter travel in Switzerland.

After these recommendations are generated, the insight system 408 can present them to a user or campaign manager through an interactive interface via the ACI system 402 that allows review, customization, and implementation. The user can modify target parameters, creative tone, or campaign priorities, and the insight system 408 can update the proposed actions accordingly. Once approved, the user can trigger campaign deployment or content generation directly from the interface. This configuration allows the insight system 408, the first insight system, and the second insight system to operate in a continuous feedback loop that aligns data-driven insights, platform targeting, and user-driven customization to optimize marketing and content execution workflows.

FIGS. 4B through 4E illustrate another example sequence diagram of an environment 400′ for generation and refinement of videos in response to receiving agent inputs, according to some embodiments. One or more aspects described herein with respect to the environment 400′ can be the same as, or similar to, those described with respect to the environment 400 of FIG. 4A. In some embodiments, the environment 400 includes an artificial creative intelligence (ACI) system 402′ (e.g., that is the same as, or similar to, the ACI system 402 of FIG. 4A), one or more client devices 404a-404e that are associated with (e.g., controlled by) individuals that are submitting requests to the ACI system 402′ to generate a set of images period, and one or more user devices 406a-406d associated with, and/or accessible by, one or more users (e.g., customers, etc.). In some embodiments, the ACI system 402′ can be the same as, or similar to, the image generation system 102 of FIG. 1.

In some embodiments, the ACI system 402′ can implement a web application 402a that is configured to be in communication with the client devices 404a-404d. The web application can provide an interface that allows for communication between the client devices 404a-404d and the ACI system 402′. The ACI system 402′ can also implement an API gateway 402b that implements an API manager that allows for access to one or more other components of the ACI system 402′ by the client devices 404a-404d.

In some embodiments, the ACI system 402′ can include an access system 402c. The access system 402c can include an access module and an admin store. The access module can be configured to control access two components of the ACI system 402′ by one or more client devices 402a-402e. The access module can also be configured to store and update data associated with access rights in the admin store. For example, the access module can be configured to store and or update data that represents permissions, capacity, utilization metadata, etc. that are associated with each of the client devices 402a-402e. In this example, the access module can obtain at least portions of the data stored in the admin store to determine whether to provide access to one or more functions that the ACI system 402′ is configured to perform (e.g., where the portions of the data stored in the admin store indicate whether one or more client devices 402a-402e are permitted to access the corresponding portions of the data).

In some embodiments, the ACI system 402′ can implement a guideline system 402d that is configured to establish and store data that is associated with one or more guidelines (e.g., brand guidelines) as described herein. In some examples, the guideline system 402d can include a guideline management module and a guideline store. The guideline management module can be configured to create and edit guidelines for content creation that can be stored in the guideline store. In some examples, the guideline management module can be configured to communicate with a prompt generator to generate aspects of one or more prompts used to generate sets of images as described herein. The guideline management module can generate and store data in the guideline store (e.g., a dataset including data that is associated with one or more guidelines) and, when coordinating with a prompt generator to generate aspects of one or more prompts, be accessed and configured (e.g., by one or more client devices 404a-404d ) to provide the data associated with the one or more guidelines during creation of images and/or content as described herein.

In some embodiments, the ACI system 402′ can include a prompt generator 402e. For example, the ACI system 402′ can include a prompt generator that is the same as, or similar to, the prompt generator 118 of FIG. 1. In some embodiments, the prompt generator 402e can include a brief management module and a brief store. For example, the brief management module can be configured to create and edit briefs (which can be the same as, or similar to, prompts as described herein). In this example, the brief management module can be configured to communicate with a brief store that stores briefs and associated metadata and content links therein.

In some embodiments, the ACI system 402′ can include a workflow engine 402f that is configured to coordinate the execution of operations performed by one or more systems or modules of the ACI system 402′ when generating sets of images. For example, the workflow engine 402f can be configured to communicate with one or more components of the prompt generator 402 e and an AI generative engine 402g that can be the same as, or similar to, the generative model 120 of FIG. 1. In examples, the workflow engine 402f can be configured to create and edit workflows of content creation tasks that are then provided to the AI generative engine 402g to cause the AI generative engine 402g to be executed and generate contents such as sets of images as described herein, text, videos, etc.

As part of the above, the ACI system 402′ can include an AI generative engine 402g. The AI generative engine 402g can be configured to receive data from the workflow engine 402f, a domain rail system 408a, and/or a proxy system 408b. In examples, the AI generative engine 402g, in response to receiving data from one or more devices and/or modules, can be configured to execute operations and generate a set of images in accordance with the data from the one or more devices described herein. The AI generative engine 402g can then be configured to provide the set of images to the domain rail system 408a and/or the proxy system 408b. In some examples, the AI generative engine 402g can receive feedback from the domain rail system 408 a and/or the proxy system 408b and execute one or more operations to update and/or generate (e.g., regenerate) the set of images.

In some embodiments, the ACI system 402′ can include an AI assistant 402h that is configured to be in communication with a brief analytics system 402i. The AI assistant 402h can be configured to cooperate with the prompt generator 402e when generating one or more prompts as described here in. For example, the AI assistant 402h can be configured to update strings of text that the prompt generator 402e is compiling to ensure consistency. The AI assistant 402h can then execute one or more operations in coordination with the brief analytics system 402i to identify similarities between briefs, gaps in coverage, analytics of configurations, and expected impacts of one or more briefs and/or prompts. The AI assistant 402h can then store data associated with the execution of one or more operations when analyzing the prompts and/or briefs described herein in the brief store of the prompt generator 402e. In some embodiments, the brief analytics system 402i can be configured to be in communication with one or more software systems that obtain information associated with market insights, or personalizations to be used when generating the sets of images described herein. For example, the brief analytics system 402i can be configured to obtain information about recent marketing campaigns, sales, etc., and provide that information to the brief analytics system 402i. In this example, the brief analytics system 402i can be configured to update one or more briefs and/or prompts in response to changes in information made available by the one or more software systems that obtain market insights, personalizations, etc.

In some embodiments, the ACI system 402′ can include an image search engine 402j that is configured to execute one or more searches to identify an image or sets of images that are responsive to request to generate sets of images. For example, the image search engine 402j can be configured to search one or more datasets managed by the ACI system 402′ or a content platform 406c in an external content databases 406d. In some examples, the image search engine 402j can compare portions of a prompt, a brief, etc., to images stored in the external content databases 406 and select one or more images that most closely match the portions of the prompt, brief, etc. As one example, the image search engine 402j can determine an embedding that represents the portions of the prompts, the brief, etc. and compare the embedding that is determined to embeddings that represent the images stored in the external content databases 406, where the embeddings that are compared are associated with a shared latent space. The image search engine 402j can then provide, or indicate, the images that were selected from the external content databases 406 to the prompt generator 402e to be incorporated into input provided to the AI generative engine 402g when generating the sets of images as described here. It will be understood that, in some examples, the external content databases 406 can be included in the ACI system 402′.

In some embodiments, the ACI system 402′ can be in communication with a content management system (CMS) 406a that is configured to store generated content and organize campaign assets that are involved in the execution of operations performed by the ACI system 402′. For example, the ACI system 402′ can generate and store sets of images in the CMS of the external content databases 406. The sets of images can then be made available for distribution via a platform distribution system 406b. In this example, the platform distribution system 406b can be configured to be in communication with one or more external systems such as a social media platform, a paid social media platform, a transaction based system such as a payment processing system, a programmatic system that allows for targeted delivery of media or content, an e-mail system, etc.

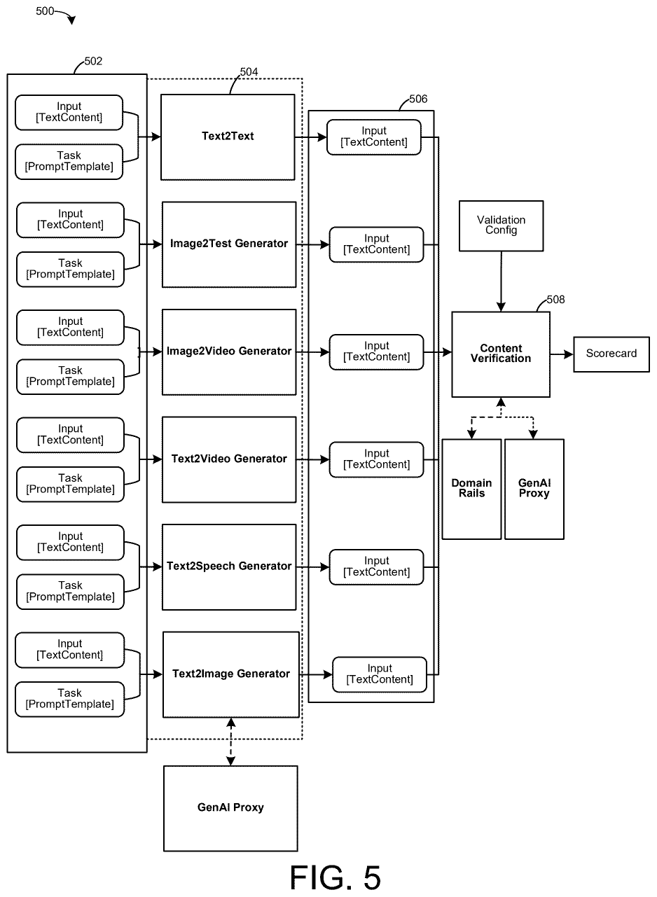

FIG. 5 is an example sequence diagram of an implementation 500 of generation and refinement of images, audio, and/or videos in response to receiving agent inputs. In some examples, one or more aspects described herein with respect to implementation 500 can be performed by one or more devices of FIG. 1. For example, operations performed by the generative model block 504 can be performed by the generative model 120 as described herein (and as well be understood, the generative model 120 can be configured in accordance with any or all of the model architectures described herein). The implementation 500 can include a task processing block 502, a generative model block 504, an aggregation block 506, and a content verification system 508. While one or more operations are described with reference to specific devices and/or components as described herein, it will be understood that any suitable device described herein can perform one or more of the operations described, unless context clearly indicates otherwise.

The implementation 500 can include the execution of a task input and prompt template processing block (referred to as a task processing block 502). The task processing block 502 can involve the execution of one or more operations to receive and coordinate task input data (e.g., structured information received from one or more client devices that represents a request or instruction for generating content, including parameters, prompts, and contextual attributes associated with the generation task) with corresponding prompt templates to form structured inputs for the generation of images and/or videos as described herein. In examples, the task processing block 502 can obtain textual or multimodal content representing requests (e.g., including plain text requests generated based on user input, prompts obtained and/or generated by a prompt generator, etc.) received from a client device that can be the same as, or similar to, the client device 104 of FIG. 1. In some embodiments, the task processing block 502 can combine the received content with specification data describing tasks to be processed by downstream components included in the generative model block 504. For example, the task processing block 502 can receive text data representing a request to generate an image, a segment of video, or a speech output and associate that data with a set of instruction parameters corresponding to a selected generator from the generative model block 504. In this example, the task processing block 502 can package the text data and task representation into a structured container object for transfer to the generative model block 504.

In some examples, the task processing block 502 can involve the execution of one or more operations to perform parsing and encoding operations to prepare the incoming task data for downstream processing. For example, the task processing block 502 can be configured to execute one or more operations to parse a text prompt obtained by the task processing block 502 to extract instruction elements such as action descriptors, stylistic attributes, or contextual modifiers and encode those elements into machine-readable fields. In at least some examples, the task processing block 502 can generate a formatted data object, such as a JavaScript Object Notation (JSON) payload, to encapsulate text instructions together with metadata identifying the desired output type, processing domain, or content category. The task processing block 502 can then transmit each packaged payload to the generative model block 504 through an internal application programming interface to allow one or more generative models as described herein to process the package payload to generate one or more images, videos, etc., as described herein. Similarly, the task processing block 502 can preprocess one or more prompt templates including text prompts maintained by one or more devices as described herein (e.g., the brief store, etc.) additional to, or alternative to, the text prompt to generate the package payload as described above.

Each task processed by the task processing block 502 can involve the execution of one or more operations to determine a generation objective that aligns with a specific generator instance within the generative model block 504. For example, a task directed to create descriptive text from provided imagery can correspond to an Image2Text generator, while a task directed to produce synthesized speech can correspond to a Text2Speech generator. In some embodiments, a task configured to cause a generator model to render visual media sequences from textual instructions can correspond to either a Text2Video generator or an Image2Video generator, depending on whether the text prompt obtained as input includes text data or image data (respectively). Other tasks indicating production of visual assets from textual input can correspond to a Text2Image generator, whereas tasks related to transformation or revision of text-based inputs can correspond to a Text2Text generator (e.g., when refining a text input to improve compatibility with one or more generators as described herein). Each task representation can include identifier fields or tags that allow for deterministic routing between the task processing block 502 and the appropriate machine learning model of the generative model block 504, maintaining data consistency and operational alignment throughout the content generation pipeline. Additionally, in instances where input from a client device indicates that image and/or text is to be generated based on a given input (e.g., input text, an image or group of images, etc.), the task processing block 502 can be configured to execute one or more of the components (e.g., machine learning models) of the generative model block in accordance with a sequence, where the output of one component is provided as an input to a different component, independent of or in addition to, the input data provided by the client device). In these examples, the task processing block can execute operations to determine the sequence based on the input provided by the client device, and subsequently execute components in accordance with this sequence.

The implementation 500 can involve the execution of one or more operations to implement a generative model block 504. The generative model block 504 can include a set of machine learning generator services (e.g., machine learning models, ensembles of machine learning models, etc.) that generate one or more types of output data in response to receiving input content and prompts. In some embodiments, the generative model block 504 can include multiple machine learning models configured to process data associated with text, image, video, and audio modalities. Each machine learning model can be configured to transform received input data into an output domain by applying one or more learned representations stored within its respective model parameters. For example, the generative model block 504 can receive inputs formatted as structured payloads from a task processing block 502 and route each payload to a generator instance that corresponds to the specified output domain.

In some examples, the generative model block 504 can include a Text2Text generator, an Image2Text generator, an Image2Video generator, a Text2Video generator, a Text2Speech generator, and a Text2Image generator. Each generator can operate as a containerized machine learning model or ensemble of machine learning models that are configured to execute a generation task by consuming prompt data together with control parameters. In this example, each container can maintain a standardized interface for receiving encoded input, executing one or more forward passes through a machine learning model, and outputting generated content to be provided to refine text prompts for generation of content (e.g., through execution of the Text2Text generator) and/or downstream components of the implementation 500 such as the content verification system 508. In at least some examples, a given generator of the generative model block 504 can use embeddings representing prompt text or contextual metadata to guide the generation of the target output. For example, a Text2Image generator can process instructional text and one or more text embeddings within a diffusion model to output an RGB image that adheres to style or composition criteria established for a given domain. In other examples, a Text2Video generator or Image2Video generator can generate video sequences by conditioning frame synthesis on both semantic and spatial data extracted from the received prompt or image input. Each generator instance can return output content and corresponding metadata through standardized service interfaces to the aggregation block 506 of for execution to different components of the generative model block 504.

### Text2Text Generator

The text2text generator can be implemented using different model architectures depending on the complexity and scale of the content generation tasks. In one embodiment, the text2text generator can include a transformer-based neural network, which further includes an attention-based model (e.g., a large language model, etc.) to capture long-range dependencies in textual input. Additionally, or alternatively, the text2text generator can include recurrent neural network architectures, including long short-term memory or gated recurrent units, to model sequential dependencies when computational efficiency or model simplicity is prioritized. In some configurations, the text2text can include a hybrid architecture combining convolutional layers and attention mechanisms can be used to encode semantic and syntactic features of the text efficiently. Each of these architectures can be initialized within modular containers that comply with uniform interfacing protocols, enabling distributed deployment within the content generation and verification pipeline.

The inputs to the text2text generator can include a text sequence provided by an upstream processing block, such as a task processing or prompt generation system, along with instruction templates or embedded vectors representing desired output attributes. These inputs can be tokenized and encoded into a numerical form that represents both lexical and contextual semantics. The text2text generator can process these encoded representations through multiple layers to synthesize a corresponding output text sequence. The generated outputs can include rewritten, summarized, or semantically enhanced text depending on the generation objective. Additionally, the generator can produce auxiliary metadata representing confidence scores or alignment values that can be used by subsequent components for validation and scoring.

During training, the text2text generator can receive input text sequences paired with target output sequences drawn from a training dataset, where the target output sequences represent the intended transformation domain. The input text sequences can be propagated forward through the layers of the machine learning model implemented by the text2text generator to produce predicted token probabilities across the vocabulary space. A loss function, such as cross-entropy loss, can then be computed by comparing the predicted output sequence against the target sequence. Backpropagation can be performed to compute gradients of the loss function with respect to the parameters of the text2text generator, and the corresponding weights of the text2text generator can be updated using an optimization algorithm such as stochastic gradient descent. This iterative configuration process can be executed until the text2text generator converges toward minimized loss values (e.g., predetermined threshold values representing a point at which loss indicates convergence of the underlying model), thereby improving its ability to generate coherent and contextually relevant textual outputs under operational conditions.

### Image2Text Generator

The image2text generator can be implemented using various model architectures depending on the type of image-to-language transformation desired. In some embodiments, the image2text generator can use an encoder-decoder architecture in which the encoder processes image features and the decoder generates corresponding text sequences. The encoder can include a convolutional neural network that extracts multi-level representations from image pixels, while the decoder can use a transformer network to process these representations and produce coherent text. Alternatively, other neural architectures such as recurrent neural networks, gated recurrent units, or hybrid convolutional-attention models can be used depending on the accuracy and efficiency requirements of the underlying system. Each model instance can be deployed within a containerized service, allowing for modular execution while maintaining standardized data interfaces across the overall pipeline.

The image2text generator can receive input data comprising an encoded image and an optional instruction template specifying content extraction parameters such as captioning style, domain constraints, or semantic emphasis. The encoded image can be represented as a tensor of pixel values or as an embedding generated by a visual encoder. The image2text generator can output a textual description, metadata summary, or structured annotation that corresponds to the visual features identified within the input image. In some configurations, the image2text generator can also produce auxiliary outputs, such as alignment confidence scores or semantic attention maps, to indicate how various regions of the image contribute to the generated text output. These outputs can then be forwarded to a content verification system 508 for evaluation and integration into larger multi-modal workflows.

Training of the image2text generator can involve providing the image2text generator with pairs of image inputs and corresponding ground truth text sequences. During a forward pass, an encoder of the image2text generator can transform images into latent feature maps, which a decoder of the image2text generator can use to predict token sequences representing textual descriptions. A loss function, such as cross-entropy loss, can be computed between the predicted output and the corresponding ground truth text sequence. Gradients of the loss function can be calculated during backpropagation, and the weights of the components of the image2text generator can be updated using an optimization algorithm such as stochastic gradient descent or adaptive moment estimation. This process can be iteratively performed over a training dataset until the model produces text outputs that accurately represent the semantic content of input images across multiple domains and conditions (e.g., until the image2text generator converges).

### Image2Video Generator

The image2video generator can be implemented using various neural network architectures depending on the design objectives, computational requirements, and types of transitions to be modeled between sequential frames. In one configuration, the image2video generator can use a generative adversarial network architecture where a generator network synthesizes motion and transitions based on still image embeddings, while a discriminator network evaluates temporal coherence between generated frames. In another configuration, the image2video generator can use a diffusion-based model that progressively refines randomly initialized noise sequences into video frames conditioned on latent vectors extracted from an input image. Other examples can include transformer-based architectures configured to attend to both spatial and temporal domains, where the transformer encoder processes input image features and a decoder module predicts subsequent frames based on learned attention weights representing motion dynamics.

The input to the image2video generator can include an encoded image tensor containing pixel information or corresponding embeddings that represent high-level visual semantics. Additional conditional inputs to the image2text generator can include motion vectors, depth maps, or textual instructions specifying the desired action or scene progression to render. The image2video generator can output a sequence of image frames constituting a short video clip, each frame represented as a multi-dimensional array of pixel values. The outputs can further include associated metadata such as frame timestamps, intermediate latent states, and optional confidence values indicating consistency with the conditioning input. These outputs can be transferred downstream (e.g., to a content verification pipeline as described herein) for validation, rendering, or recombination with audio and text streams within the content generation pipeline.

During training, the image2video generator can receive pairs of input images and target video sequences representing expected temporal transitions. The input image can be encoded through a visual encoder, while the target frames are processed through a decoder that predicts frame-by-frame motion trajectories. A loss function can be calculated by comparing the generated frames to the ground truth frames using metrics such as mean squared error or perceptual similarity loss. The gradients of this loss function can then be computed during backpropagation to adjust the parameters of convolutional, attention, or diffusion layers within the image2text generator. Through iterative training across a large dataset, the weights and biases of the image2text generator can be refined to minimize reconstruction error and improve its ability to generate temporally coherent, visually aligned video outputs from static input images.

### Text2Speech Generator

The text2speech generator can be implemented using various neural network architectures depending on the intended processing objectives and desired fidelity of generated audio. In one configuration, the text2speech generator can use an encoder-decoder architecture in which the encoder transforms textual input into a latent feature representation and the decoder converts that representation into an acoustic waveform. The encoder can include a transformer-based model to capture contextual dependencies within text sequences, while the decoder can include autoregressive or diffusion-based components that synthesize temporally coherent speech samples. Alternative model architectures can include convolutional neural networks constructed to model temporal correlations across short-time spectral frames or recurrent neural networks configured to process text sequences in continuous time. Each of these architectures can be modularly deployed within computing environments that support unified interfacing and scalable training.

Inputs to the text2speech generator can include a textual sequence and one or more instruction templates that define the desired speaking style, emotional tone, etc., of the speech output. The textual sequence can be tokenized and embedded into numerical vectors representing linguistic content, while the instruction templates can encode contextual parameters such as tempo or desired voice characteristics. These encoded representations can be sequentially or jointly processed by the encoder to form latent features that the decoder interprets when generating speech waveforms. The output of the text2speech generator can include synthesized audio data represented as either spectral magnitude frames or time-domain waveforms along with optional metadata such as phoneme alignment maps, pitch contours, or confidence scores. These outputs can be provided to downstream modules for playback, verification, or integration into multimedia content pipelines.

Training of the text2speech generator can involve the use of paired text and speech datasets in which textual transcripts correspond to ground truth audio recordings. During each iteration of training, the text2spech generator (including components thereof) can receive the input text sequence and can predict a reconstructed spectrogram or waveform that approximates the target audio. The generated output can be compared to the reference audio using a loss function such as mean squared error or a spectral convergence loss to quantify reconstruction performance. Gradients of the computed loss can be propagated backward through both the encoder and decoder layers to update network weights using optimization algorithms such as stochastic gradient descent or adaptive moment estimation. Through iterative application of forward inference and backpropagation, the text2speech generator can learn mappings between textual and acoustic domains that enable accurate and natural speech synthesis during operational use.

### Text2Image Generator

The text2image generator can be implemented using a variety of machine learning architectures depending on the output precision and desired visual fidelity. In one embodiment, the text2image generator can use a diffusion-based model in which an input text embedding controls the progressive denoising of a latent variable to produce an image. In another embodiment, the text2image generator can use a transformer-based network where attention layers model associations between textual tokens and image regions, thereby allowing for logical alignment between descriptive terms and spatial structures. In other configurations, the text2image generator can use a generative adversarial network architecture, in which a generator is trained to synthesize images while a discriminator evaluates their correspondence to the original text input. Each architecture can be deployed as a modular service that interfaces with upstream text encoders and downstream scoring systems within the broader content generation environment.

The inputs to the text2image generator can include text data representing a descriptive phrase, sentence, or paragraph that specifies content elements for image synthesis. The input can be converted into a numerical embedding using a text encoder that captures the semantic meaning of the input sequence. Optional conditioning parameters such as color palettes, aspect ratios, or stylistic descriptors can also be provided to further constrain the generated outputs. The output of the text2image generator can include one or more images represented as multidimensional pixel arrays or encoded tensors suitable for downstream rendering or additional post-processing. Each image can incorporate metadata describing the relationship between the textual descriptors and visual elements, allowing for traceability and facilitating later validation or scoring by a verification subsystem.

During training, the text2image generator can receive pairs of text descriptions and target images from a training dataset that captures a wide variety of object classes, scenes, and contextual relationships. The text2image generator can process each input text sequence through an encoder to obtain a latent representation, which is then provided to the generator network responsible for producing a corresponding image. The generated image can be compared to the reference image using one or more loss functions such as reconstruction loss, perceptual loss, or adversarial loss, depending on the architecture employed. Gradients computed from these losses are propagated backward through the network layers to update weights of the text2image generator, progressively improving the alignment between text semantics and generated imagery. This iterative process continues until the generator achieves convergence under the defined evaluation metrics, allowing the text2image generator to produce images consistent with input descriptions under operational conditions.

The implementation 500 can include a post-generation content input aggregation block (referred to as an aggregation block 506). The aggregation block 506 can receive outputs generated by one or more generator instances of the generative model block 504 and prepare those outputs for downstream validation. In some embodiments, the aggregation block 506 can collect generated items such as images, text, videos, or speech, as produced by the various model containers of the generative model block 504. In examples, the aggregation block 506 can aggregate content items of heterogeneous types and associate each content item with corresponding task metadata for subsequent validation processes. For example, the aggregation block 506 can correlate generated output data with an originating input prompt or template identifier and transmit the correlated dataset to a content verification system 508 for evaluation. In some embodiments, the aggregation block 506 can apply formatting and normalization operations before transferring the data to the content verification system 508. For example, the aggregation block 506 can merge JavaScript Object Notation (JSON) payloads, flatten nested or multi-format objects within the aggregated data, and generate unified content packages that are transmitted to the content verification system 508 for validation and scoring.

The implementation 500 can include a content verification system 508. The content verification system 508 can be a computing system that performs evaluation, validation, and scoring of generated output items originating from the aggregation block 506. In some embodiments, the content verification system 508 can compare each generated item to a set of configured guidelines or operational boundaries identified as domain rails (e.g., a set of predefined constraints, validation rules, and operational parameters that ensure generated content adheres to domain-specific, stylistic, or organizational standards). For example, the content verification system 508 can retrieve constraint data from the domain rails and determine whether visual, textual, or auditory elements of the generated content comply with defined structural or stylistic parameters. The content verification system 508 can perform automated comparison operations to determine conformance levels for multiple attributes such as layout composition, media type compatibility, and adherence to contextual brand requirements.

In some embodiments, the content verification system 508 can execute programmed scoring routines associated with the domain rails to compute validation metrics for each generated item. The scoring routines can include numerical evaluations of compliance and qualitative assessments of contextual alignment. In examples, the content verification system 508 can process output data through one or more computational pipelines implemented in a scripting framework such as a Python-based validation subsystem. In this example, the content verification system 508 can apply numerical weightings to determine aggregate content quality scores and generate corresponding scorecards. Each scorecard can represent evaluated attributes such as compliance with brand rules, representation quality, and consistency with stylistic embeddings. The scorecard can be generated as structured data usable by downstream refinement processes that adjust generative inputs or prompt configurations for subsequent iterations of content generation.

In some examples, the content verification system 508 can be implemented using one or more model architectures depending on the objectives of evaluating generated outputs. In one example, the content verification system can implement a transformer-based architecture where the attention layers capture correlations between input prompts, generated outputs, and guideline references. In another example, the content verification system can use a convolutional neural network that identifies patterns or inconsistencies within image or video data according to domain constraints. Alternatively, a recurrent neural network can be used in cases where the generated output has temporal dependencies, such as in video streams or sequential text data. Each model architecture can operate independently or in combination to analyze multimodal input data, allowing the content verification system to perform context-specific analysis under unified control logic to generate outputs indicating whether the input data (received from one or models from the generative model block 504) does or does not match an expected output based on the data processed at the task processing block 502.

Inputs to the content verification system can include generated content items such as images, text, videos, or audio, along with corresponding prompts, templates, or reference guidelines (e.g., processed as input at the task processing block 502 or obtained from one or more systems such as a prompt generator as described herein). These inputs can be encoded into numerical representations that preserve structural and semantic information. For instance, an image input can be converted into a tensor representation of pixel values, while textual data can be tokenized and represented as embeddings by a text encoder. The outputs of the content verification system can include one or more validation metrics indicating compliance with configured standards, qualitative attributes identifying deviations, and a composite score representing alignment with domain rails. These outputs can be formatted as structured data records, enabling downstream systems to automatically determine acceptance, flag non-compliant items, or trigger reprocessing operations when deviations are detected.

The content verification system 508 can be trained using a dataset containing pairs of generated outputs and corresponding evaluation labels that represent the desired compliance or conformance outcomes. During training, the input data can be processed by the model to predict validation scores, which are compared to the ground truth labels to compute a loss value. The gradients of the loss function can then be determined through a backpropagation process, which quantifies how each model parameter contributed to the error. The weights of the content verification system 508 can be updated using optimization algorithms such as stochastic gradient descent to reduce the discrepancy between predicted and reference outcomes. This iterative process can continue until the system converges to a stable set of parameters, allowing the content verification system 508 (including components thereof) to accurately assess compliance and output precise scores when evaluating new generated content.

With continued reference to FIG. 5, in some embodiments, the input data associated with the task processing block 502 can be generated and provided to one or more machine learning models included in the generative model set 504. For example, a prompt generated based on input (e.g., a request to generate a set of images) provided by a content creator (e.g., an individual controlling a client device 104) can be combined with a project template. The project template can include, for example, a system prompt provided to guide the generation of a set of images in accordance with one or more predetermined criteria (e.g., brand guidelines, etc.). In examples, the input data can include a first image that is selected by the content creator. In some examples, the input data can include text provided by the content creator, speech provided by the content creator, additional images provided by the content creator that are provided in addition to the selected image, and/or videos that are provided by the content creator in addition to the selected image. In some embodiments, the input can be provided to one or more machine learning models of the generative model set 504. The machine learning models of the generative model set 504 can include a text to text generator that is configured to generate text from the input data and an instruction template. In examples, the machine learning models can include an image to text generator that is configured to generate text from the input data. In some examples, the machine learning models can include an image to video generator that is configured to generate video from the input data. In examples, the machine learning models can include a text to video generator that is configured to generate video the input data. In some examples, the machine learning models can include text to speech generator that is configured to generate speech from the input data. And in some examples, the machine learning models can include a text to image generator that is configured to generate images from the input data. As described herein, the instructions can include a prompt, a group of prompts combined to form a single prompt, etc. In response to receiving the input data described herein, one or more machine learning models from the generative model set 504 can output a set of images, text, or combinations thereof. The output of one or more of the machine learning models in the generative model set 504 can be provided to a content verification system 508 that is configured to receive the input and execute one or more operations to determine whether the input satisfies the input provided by the content creator. Additionally, or alternatively, the content verification system 508 can be configured to generate a score indicative of a degree to which the output of the one or more machine learning models conforms to the request to generate the set of images.

In an example, textual data to be used for generating advertisement content can be received from a client device and processed in accordance with the implementation 500. For example, the task processing block 502 can obtain the text from the client device and combine it with corresponding task parameters or templates that define how the advertisement content is to be generated. The text and associated parameters can then be provided to one or more machine learning models included in the generative model block 504 to cause generation of one or more outputs such as images, videos, or text variations suitable for use in advertisement campaigns. Once generated, the outputs can be aggregated by the aggregation block 506 and validated through the content verification system 508. In response to successful validation, the resulting advertisement content can be provided as output to be displayed either on the client device (e.g., for review by an individual generating the advertisement) or on a user device (e.g., of a customer, end-user, or reviewer) for presentation, publication, or further processing within a campaign workflow.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of this disclosure or the claims.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing or receiving information, data, arguments, parameters, or memory contents. Information, arguments, parameters, data, etc., can be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When any of the computing devices described herein implement one or more functions, these functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate the transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes or instructions on a non-transitory processor-readable medium or computer-readable medium, which can be incorporated into a computer program product.

The implementation of functions described herein can involve the use (e.g., programming or configuring of) one or more devices such as processing circuits, processors, computer-readable mediums (CRM), or similar technologies. These devices can be implemented by a single server or a distributed computing environment of multiple servers, which include, but are not limited to, a cloud computing environment. Furthermore, unless otherwise specified, the terms “a” processing circuit, processor, or CRM can refer to one or more instances of such processing circuits, processors, or CRMs. This means that the features described can be executed on a single device or distributed across multiple devices for processing and storage.

The preceding description of the disclosed embodiments is provided to enable any person skilled in the art to make or use the embodiments described herein and variations thereof. Various modifications to these embodiments will be readily apparent to those skilled in the art, and the principles defined herein can be applied to other embodiments without departing from the spirit or scope of the subject matter disclosed herein. Thus, the present disclosure is not intended to be limited to the embodiments shown herein but is to be accorded with the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system for generating sets of images responsive to requests having diverse semantic meanings, the system comprising:
at least one processing circuit comprising at least one memory and one or more processors, the one or more processors configured to:
obtain, from a client device, a request to generate a set of images, the request indicating one or more aspects to represent in the set of images;
determine, responsive to the request, a first image from among a dataset comprising a plurality of predetermined images using the one or more aspects;
provide the first image and a prompt to a machine learning model to cause the machine learning model to generate the set of images as an output, the prompt comprising one or more predetermined criteria,
wherein providing the prompt to the machine learning model configures the machine learning model to generate the set of images in accordance with the one or more predetermined criteria; and
in response to obtaining the set of images from the machine learning model, provide the set of images to cause the client device to display at least one image of the set of images.

2. The system of claim 1, wherein the one or more processors are further configured to:
provide the first image to the client device to cause the client device to display the first image; and
in response to providing the first image to the client device, obtain a confirmation from the client device to use the first image to generate the set of images.

3. The system of claim 1, wherein the one or more processors are further configured to:
provide the first image to the client device to cause the client device to display the first image; and
in response to providing the first image to the client device, obtain a confirmation from the client device not to use the first image to generate the set of images;
provide a plurality of images to the client device to cause the client device to display at least one image from among the plurality of images; and
in response to providing the plurality of images to the client device, obtain a confirmation from the client device indicating a selected image from among the plurality of images.

4. The system of claim 1, wherein the one or more processors are further configured to:
provide a plurality of images comprising the first image to the client device to cause the client device to display at least the first image; and
in response to providing the plurality of images to the client device, obtain a confirmation from the client device indicating the first image from among the plurality of images.

5. The system of claim 1, wherein the one or more processors are further configured to:
determine a context from the request based on the one or more aspects indicated by the request to generate the set of images, and
wherein the one or more processors configured to determine the first image are configured to:
filter the dataset for a subset of predetermined images that are compatible with the context; and
determine the first image from the subset of predetermined images based on the one or more aspects indicated by the request to generate the set of images.

6. The system of claim 5, wherein the one or more processors are further configured to:
extract a first embedding from the one or more predetermined criteria using an encoder, the first embedding representing a style, and
wherein the one or more processors configured to cause the machine learning model to generate the set of images are configured to:
provide the first embedding to the machine learning model to cause the machine learning model to generate the set of images in accordance with the style.

7. The system of claim 1, wherein the request to generate the set of images comprises a first request to generate a first set of images, and
wherein the one or more processors further configured to:
obtain a second request to generate a second set of images, the second request comprising an updated prompt configured to cause the machine learning model to generate the second set of images in accordance with one or more updates; and
provide the first image and a second prompt to the machine learning model to cause the machine learning model to generate an updated set of images as a second output, the second prompt comprising the prompt, the updated prompt, and the one or more predetermined criteria.

8. The system of claim 1, wherein the request to generate the set of images comprises a first request to generate a first set of images,
wherein the one or more processors are further configured to:
obtain a second request to generate an updated set of images based on a second image;
determine the second image based on the second request, the second image included in the dataset comprising the plurality of predetermined images; and
provide the second image and the prompt to the machine learning model to cause the machine learning model to generate an updated set of images as a second output.

9. The system of claim 1, wherein the request to generate the set of images comprises a first request to generate a first set of images, and
wherein the one or more processors are further configured to:
obtain a second request from client device to update the set of images, the second request comprising a second prompt indicating one or more updated aspects to represent in an updated set of images;
provide the first image and a third prompt to the machine learning model to cause the machine learning model to generate the updated set of images as a second output, the third prompt comprising the prompt, the second prompt, and the one or more predetermined criteria.

10. The system of claim 9, wherein the one or more processors are further configured to:
determine an updated context from the second request based on the one or more updated aspects indicated by the second prompt,
filter the dataset for an updated subset of predetermined images that are compatible with the updated context;
determine a second image from the updated subset of predetermined images based on the one or more aspects indicated by the second prompt; and
provide the second image and a third prompt to a machine learning model to cause the machine learning model to generate the updated set of images as a second output, the third prompt comprising the second prompt and the one or more predetermined criteria.

11. The system of claim 1, wherein the one or more processors are further configured to:
in response to obtaining the set of images as the output of the machine learning model, provide the set of images to an agent-based machine learning model to cause the agent-based machine learning model to output a score;
compare the score to an approval threshold value established for an organization; and
in response to comparing the score to the approval threshold value, providing the set of images to one or more user devices to cause the one or more user devices to display at least one image of the set of images.

12. The system of claim 1, wherein the one or more processors are further configured to:
in response to obtaining the set of images as the output of the machine learning model, provide the set of images to an agent-based machine learning model to cause the agent-based machine learning model to output a score;
in response to comparing the score to an approval threshold, determine that the score does not satisfy the approval threshold; and
apply one or more updates to the prompt to configure the machine learning model to generate an updated set of images as a second output; and
provide the updated set of images to cause the client device to display at least one image of the set of images.

13. A method, comprising:
obtaining, by one or more processing circuits and from a client device, a request to generate a set of images, the request indicating one or more aspects to represent in the set of images;
determining, by the one or more processing circuits and responsive to the request, a first image from among a dataset comprising a plurality of predetermined images using the one or more aspects;
providing, by the one or more processing circuits, the first image and a prompt to a machine learning model to cause the machine learning model to generate the set of images as an output, the prompt comprising one or more predetermined criteria,
wherein providing the prompt to the machine learning model configures the machine learning model to generate the set of images in accordance with the one or more predetermined criteria; and
in response to obtaining the set of images from the machine learning model, providing, by the one or more processing circuits, the set of images to cause the client device to display at least one image of the set of images.

14. The method of claim 13, further comprising:
providing, by the one or more processing circuits, the first image to the client device to cause the client device to display the first image; and
in response to providing the first image to the client device, obtaining, by the one or more processing circuits, a confirmation from the client device to use the first image to generate the set of images.

15. The method of claim 13, further comprising:
providing, by the one or more processing circuits, the first image to the client device to cause the client device to display the first image;
in response to providing the first image to the client device, obtaining, by the one or more processing circuits, a confirmation from the client device not to use the first image to generate the set of images;
providing, by the one or more processing circuits, a plurality of images to the client device to cause the client device to display at least one image from among the plurality of images; and
in response to providing the plurality of images to the client device, obtaining, by the one or more processing circuits, a confirmation from the client device indicating a selected image from among the plurality of images.

16. The method of claim 13, further comprising:
providing, by the one or more processing circuits, a plurality of images comprising the first image to the client device to cause the client device to display at least the first image; and
in response to providing the plurality of images to the client device, obtaining, by the one or more processing circuits, a confirmation from the client device indicating the first image from among the plurality of images.

17. The method of claim 13, further comprising:
determining, by the one or more processing circuits, a context from the request based on the one or more aspects indicated by the request to generate the set of images, and
wherein determining the first image are configured to:
filtering, by the one or more processing circuits, the dataset for a subset of predetermined images that are compatible with the context; and
determining, by the one or more processing circuits, the first image from the subset of predetermined images based on the one or more aspects indicated by the request to generate the set of images.

18. The method of claim 17, further comprising:
extracting, by the one or more processing circuits, a first embedding from the one or more predetermined criteria using an encoder, the first embedding representing a style, and
wherein causing the machine learning model to generate the set of images comprises:
providing, by the one or more processing circuits, the first embedding to the machine learning model to cause the machine learning model to generate the set of images in accordance with the style.

19. The method of claim 13, wherein the request to generate the set of images comprises a first request to generate a first set of images,
the method further comprising:
obtaining, by the one or more processing circuits, a second request to generate a second set of images, the second request comprising an updated prompt configured to cause the machine learning model to generate the second set of images in accordance with one or more updates; and
providing, by the one or more processing circuits, the first image and a second prompt to the machine learning model to cause the machine learning model to generate an updated set of images as a second output, the second prompt comprising the prompt, the updated prompt, and the one or more predetermined criteria.

20. One or more non-transitory computer-readable media comprising instructions which, when executed by one or more processors, cause the one or more processors to:
obtain, from a client device, a request to generate a video, the request indicating one or more aspects to represent in the video;
determine, responsive to the request, a first image from among a dataset comprising a plurality of predetermined images using the one or more aspects;
provide the first image and a prompt to a machine learning model to cause the machine learning model to generate the video as an output, the prompt comprising one or more predetermined criteria,
wherein providing the prompt to the machine learning model configures the machine learning model to generate the video in accordance with the one or more predetermined criteria; and
in response to obtaining the video from the machine learning model, provide the video to cause the client device to display at least one image of the video.
